(19) United States
(12) Patent Application Publication
(10) Pub. No.: US 2018/0373861 A1
(43) Pub. Date: Dec. 27, 2018

(54) Time-Based Digit Entry Method to Verify Identification Constructs

(71) Applicant: Joseph Carlo Pastrana, Hampton, VA (US)

(72) Inventor: Joseph Carlo Pastrana, Hampton, VA (US)

(21) Appl. No.: 15/632,330

(22) Filed: Jun. 24, 2017

(51) Int. Cl. G06F 21/40; G06F 21/36; G06F 21/31

(52) U.S. Cl. CPC G06F 21/40; G06F 2221/2133; G06F 21/31; G06F 21/36

(57) ABSTRACT

A computer-implemented authentication method to enter, in a time-controlled system, a digit or a segment of an identification or account construct, and where the construct and its segments are comprised of numbers, and/or characters, and/or symbols. The time-based digit or segment of the identification-account construct or data is programmed to be entered within a prearranged time range into a computer system. The method is designed to be utilized by software driven devices and used as a process for user's authentication. As the user interfaces with the software driven device, it requires the user to select the location of the time-based digit or segment within the user's identification information; use a stopwatch to select a time value within his identification construct prearranged time range; enter the time-based digit or segment of the identification construct; and enter the remaining data construct for authentication.

### CROSS-REFERENCE TO RELATED APPLICATIONS

Not applicable to this application

### FEDERALLY SPONSORED RESEARCH OR DEVELOPMENT

Not applicable to this application

### SEQUENCE LISTING, A TABLE, OR A COMPUTER PROGRAM LISTING

Not applicable to this application

### COMPACT DISC APPENDIX

Not applicable to this application

### STATEMENT REGARDING PRIOR DISCLOSURES BY THE INVENTOR

Not applicable to this application

### BACKGROUND OF THE INVENTION

The technical field of the invention relates to the security of computer information systems or portable computing devices, such as a laptop, tablet, iPad, cellular telephone, or the like. More particularly, the present invention relates to the field of login authentication and data required to be securely entered. When a user is initiating an interface with a computerized information system, entering identification information, or some form of login data, an authentication of the login data is almost always required. For example, login methods, such as the method of a user at the client console simply inputting a username and password, which is verified by the server, or methods of login involving one-time password keys, where a password works only once, are used for user authentication.

These and other methods still unable to avoid security problems, especially when an unauthorized person obtains an authorized user's login information to obtain illicitly access into a secured computer system. Accordingly, improved systems and methods for user login authentication and data entry remain highly desirable.

### BRIEF SUMMARY OF THE INVENTION

A computer-implemented authentication method designed to enter, in a time controlled system and within a prearranged location, a digit or a segment of an identification construct (e.g. User ID, Password, Account Number, Personal Identification Number or Data) within a prearranged time range into a software driven device such as a computer and where the identification construct and its segment is comprised of numbers, and/or characters, and/or symbols. The location and the prearranged time range of the time-based digit or the time-based segment are only known to the user. The method is designed to be computer program coded and integrated into software driven devices (SDD) and used as a process for user's authentication. The method corroborates the user's selected location of the identification's time-based digit (or time-based segment) and his selected time value by comparing his/her selections with the data values stored in the database. Software Driven Devices (SDD) comprise devices such as computers, user ID/Password controlled electronic apparatuses, or portable computing devices, such as laptops, tablets, iPads, or cellular telephones.

As the user starts interfacing with the SDD, the SDD requires the user, via the computer screen (the device's display), to identify and select the location of the digit or segment within the user's identification construct or data which has been prearranged with a time range. To achieve this step, the computer screen provides the user with a login pattern, depicting a specific number of spaces, which is used by the user to identify and select the exact location of the digit, character, symbol or segment within the identification construct that is Time-Based.

Afterward (after the user's selection of the time-based digit or segment), the SDD requires the user to commence entering the identification number or data up to the time-based digit or up to the first element of the segment that is time-based programmed. At this point, once the user enters the digits preceding the time-based digit or segment, the SDD starts running a Stopwatch and require the user to stop it within the prearranged time range of the time-based digit or segment of the identification construct. The user stops the stopwatch by entering the time-based digit or the last element of the time-based segment.

After the user stops successfully the stopwatch within the required prearranged time range, the SDD continues and requires the user to enter the remaining of the identification construct or data. If the location and time value of the time-based digit or segment entries are correct and the remaining identification construct was entered correctly, the user gains access to the software driven device.

The method is designed to be computer program coded, integrated and operated by a SDD or a computer information system, which is comprised of a processor, database system, entry device, and an application software to process the data entered. The method may also be used in more portable computing devices, such as a laptop, tablet, iPad, cellular telephone, or the like.

The method provides an additional security authentication layer by assigning the user with an identification construct that contains a prearranged time-based digit or time-based segment that it is only known to the user. For example, if an unauthorized user acquires the identification number of an authorized user but does not know which segment of the identification number is time-based and does not know the time range of the time-based segment, the unauthorized person will be prevented by the method from gaining access to the software driven device (SDD).

### BRIEF DESCRIPTION OF THE SEVERAL VIEWS OF THE DRAWINGS

The following figures are included to illustrate certain aspects of the present invention, and should not be viewed as exclusive embodiments. The subject matter disclosed is capable of considerable modification, alteration, and equivalents in form and function, as will occur to one having ordinary skill in the art and the benefit of this disclosure.

FIG. 1 (Page 1) depicts a schematic of a dialogue tree (screens-user interface).

FIG. 2 (Page 2) depicts stopwatch on a desktop computer screen after being stopped by the user at 3.73 seconds.

### DETAILED DESCRIPTION OF THE INVENTION

The following description of the embodiments of the invention is not intended to limit the invention to these mentioned embodiments, but rather to enable any person skilled in the art to make and use this invention. The embodiment of the invention includes, but is not limited, to a method to enter identification constructs or data into software driven devices. The subject matter disclosed is capable of considerable modification, alteration, and equivalents in form and function, as will occur to one having ordinary skill in the art and the benefit of this disclosure and it is to be accorded the widest scope consistent with the principles and features disclosed herein.

The invention is a computer-implemented authentication method designed to enter, within a prearranged time range and within a prearranged location, a digit(s) and/or a character(s) and/or a symbol(s), and/or a segment(s) of an identification construct (e.g. User ID, Password, Account Number, Personal Identification Number or Data) into software driven devices (SDD) such as a computer, user ID/Password controlled electronic apparatuses, or portable computing devices, such as laptops, tablets, iPads, or cellular telephones. The location and the prearranged time range of the digit (or character, symbol or segment) of the identification construct are only known to the user and they are security features of this invention. The identification construct is comprised of numbers, and/or characters, and/or symbols. The numbers, characters, symbols and segments of the identification construct with a prearranged location and time range are also known by the term “time-based”. Further, the entire identification construct can also be set as a time-based unit.

For simplicity purposes, the abovementioned “SDD” acronym, will be used throughout the patent application to refer to computers, computer systems, network information systems, user ID/Password controlled electronic apparatuses, or portable computing devices, such as a laptop, tablet, iPad, or a cellular telephone. Also, and for simplicity purposes, the aforesaid term “segment” will be used throughout the patent application to refer to the section of an identification construct or data that is comprised of digit(s), and/or character(s), and/or symbol(s), and which has been programmed (prearranged) with a Time Range.

The method requires the user to identify and select the time-based digit or time-based segment of his assigned identification construct and to time such digit and/or segment. This time-based digit or time-based segment have a prearranged (programmed) time range and it must be entered into the computer system within its allowed time range. To identify and select the time-based digit or time-based segment of the identification construct, the user uses a login pattern shown on the device's screen (display) which depicts the specific number of spaces of the identification construct. To time the segment, the user utilizes a Stopwatch. The method corroborates the user's selected location of the time-based digit or time-based segment and his selected time value by comparing his/her selections with the data values stored in the database. The method is designed to be computer program coded (programmed), integrated and utilized by software driven devices (SDD) and used as a process for user's authentication.

To amplify the explanation on the above paragraph (013), the user starts the login process by identifying the time-based digit or time-based segment of his identification construct. To identify and select the time-based digit or time-based segment, the user utilizes a login pattern shown on the device's screen which depicts the specific number of spaces of the identification construct. Once the user makes his selection, the user continues the login process by entering the preceding digits/character/or symbols to the time-based digit or segment of the identification construct, which is required by SDD.

After the user enters the preceding digits to the time-based digit or time-based segment, the user is then required by the SDD to operate a software driven stopwatch which is computer program coded and integrated into the SDD. After the preceding digits are entered, the device's display (or computer screen) shows to the user the stopwatch, which started running after the SDD received the last digit of the preceding digits (or symbols or characters) entered by the user. As the SDD runs the stopwatch, the user must stop it within the prearranged time range assigned to the time-based digit or segment of his/her identification construct. Thus, the user times the time-based digit or segment. To stop the stopwatch, the user enters the time-based digit or the SDD stops the stopwatch once it receives the last element of the time-based segment entered by the user. If the stopwatch is stopped within the time range of the time-based digit or segment, then the SDD continues with the login process.

After the stopwatch is successfully stopped (within the allowable time range), the user enters the remaining digits, characters or symbols of the user's identification construct, as required by the SDD, to complete the process of authenticating the user's identification information.

To accomplish the process of authentication, the method uses a computer program code to compare the prearranged time range and location of the time-based digit(s) or segment stored in the database to the identification construct data entered by the user. Thus, the comparison occurs when the data stored in the database is compared to the data entered by the user (selected location and time values).

To initiate a computer interface with the SDD and to enter the authentication construct into the SDD, the user utilizes an entry apparatus device (e.g. Computer Keyboard).

For instance, as an example and without limiting the invention, a user is at his desktop computer, initiating a login into a Network Information System (NIS), and the NIS starts the interface with the user by providing the user with a computer screen (display device), which requests the user to identify the digit(s) or segment(s) of his/her 8-digit identification construct that is (are) Time-Based. The computer screen provides the request to the user through a depiction of a login pattern, which is elucidating and represents the number of spaces of the identification construct. On this example, eight spaces are depicted on the computer screen to accommodate the 8-digit identification construct of the user. Also, as part of this example, the fifth digit of the user's 8-digit identification construct is the time-based digit. The 8-digit identification construct is his Personal Identification Number (PIN).

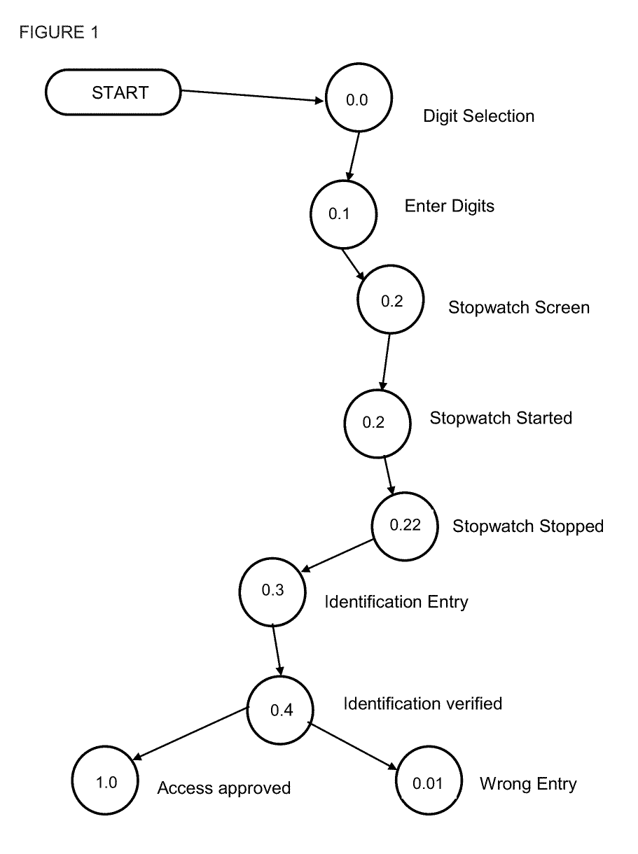

To respond to the time-based digit identification request made by the NIS, the user selects the fifth digit as the position of time-based digit of his identification construct. The selection is made when the user “click” on the fifth space of the 8 digit spaces depicted on the screen, which were representing the numbers of his identification construct. After the selection is made by the user (identifying the location of the time-based digit within the identification construct), the entry is processed by the NIS. Afterward, the NIS proceed to the second screen which is depicted as node 0.1 on FIG. 1. The first screen (requesting the selection of the time-based digit) is depicted on FIG. 1 as node coded 0.0 of the Dialogue Tree.

On the second screen, see node coded 0.1 on FIG. 1, the computer code of the NIS directs the user and asks the user to provide the first 4 digits of his identification construct. After the user enters the first 4 digits, the NIS proceed to provide to the user with a third screen, which is depicted on FIG. 1 as node 0.2.

The third screen (see node coded 0.2), provides the user with a stopwatch. At this point, the user must time the fifth digit with the stopwatch. On this example, the prearranged time range of the fifth digit is any value between 3.00 to 3.99 seconds. Also on this example, the computer system automatically starts the stopwatch after the entry of the last of first 4 digits of the identification construct. As the stopwatch runs, the user must stop the stopwatch within the 3.00 to 3.99 seconds time range. To stop the stopwatch, the user enters the fifth digit (the time-based digit) within the prearranged time range (between 3.00 to 3.99 seconds) into the SDD. The fifth digit entry is made by “keying” (inputting) the number that represents the fifth digit.

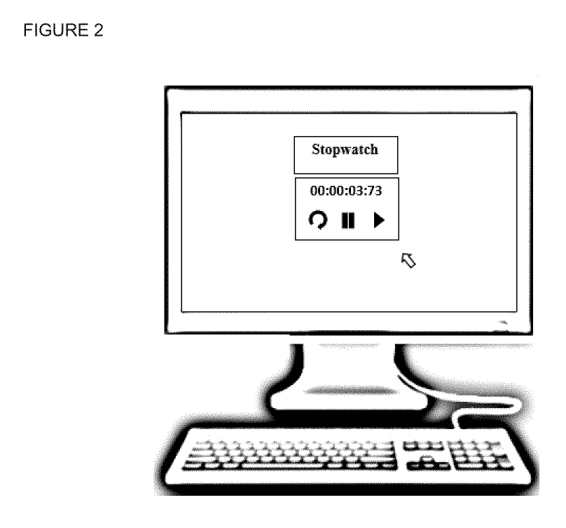

If the user stops the stopwatch between the 3.00 to 3.99 seconds range, depicted on node coded 0.22 of FIG. 1, the NIS provides to the user a fourth screen depicted on FIG. 1 as node 0.3, to complete the entry of the remaining three digits of the identification construct. In this example (see FIG. 2), the stopwatch is depicted as being stopped by the user at 3.73 seconds. Hence, the user stopping it successfully.

If the user does not stop the stopwatch within the allowable time range, the NIS could provide another opportunity to the user to have the time-based digit timed or clocked. This option must be coded into the software program of the NIS if wanted by the owner of the System (NIS).

After the user completes the entry of the remaining digits of the eight-digit identification construct, the NIS, using its database, proceed to compare and verify the identification construct's digits, the digit chosen as the time-based digit, and the time value selected by the user to be assigned to the time-based digit. If all the entries are correct, the NIS then enables the user to gain access to the system and to manage the data stored thereon. See FIG. 1, node 1.0.

If the NIS does not validate the identification construct entered by the user, the NIS then provides the user with a different screen to let the user know that the entered identification construct was not validated. See FIG. 1, node 0.01.

The abovementioned description of the embodiments of the invention is not intended to limit the invention. The invention is capable of considerable modification, alteration, and equivalents in form and function and can be utilized in numerous computerized information systems and software driven devices.

For instance, it could be a computer implemented method to enter a time-based digit to be used as a probability game during the login process by utilizing the Time-Based Digit's time entered by the user in response to an effort by the user to meet the system owner's instruction to stop the stopwatch at a specific fraction of a second within the user's prearranged Time-Based Digit to acquire, by chance/probability, a benefit.

For example, if a user is initiating a login process at a retailer's website which has this method (described in paragraph 028) integrated into the login's software, the login screen of the retailer's website could let the user know before he starts and stops the stopwatch that if he stops the stopwatch at exactly 3.44 seconds, the retailer will give him a 10% discount for any purchases made by him during that day. Consequently, transforming the login process into a dual-purpose activity where the authentication of the user as well as a probability game are taking place simultaneously.

### SEQUENCE LISTING

Not Applicable

I claim:

1. A computer-implemented method to enter, in a prearranged time range-based manner, a digit, and/or a character, and/or symbol and/or a segment of an identification construct, said method comprising the steps of:
a) a user identifying and selecting the specific location of the digit, character, symbol or segment within the user's identification construct that have a prearranged time range via a login pattern depicting the number of spaces of the identification construct;
b) a user entering the digits, and/or characters, and/or symbols and/or segments of the user's identification construct that are located before the prearranged time range element of the identification construct;
c) a software driven stopwatch that will start running after the entry of the last digit, character, symbol or segment preceding the prearranged time range digit, character, symbol or segment of the identification construct;
d) a user stopping the software driven stopwatch with the entry and within the prearranged time range of the digit, character, symbol or segment of the identification construct that has been programmed with a time range;
e) a user entering the remaining digit(s), and/or character(s), and/or symbol(s) and/or segment of the user's identification construct;
f) a database search is initiated by the computer device to compare the values entered by the user with the user's identification stored data to corroborate user identification information after the user completes the entry of the identification construct;
g) a computer device providing a message through the computer device's display that the login process was successful or that the login process was not successful after the comparison of the user's entered values with the data stored in the database.

2. The computer-implemented method to enter, in a prearranged time range-based manner, a digit, and/or a character, and/or symbol and/or a segment of an identification construct of claim 1, wherein said identification construct is composed of a digit or digits, and/or a character or characters, and/or symbol or symbols and the identification construct is the user's assigned identification information.

3. The computer-implemented method to enter, in a prearranged time range-based manner, a digit, and/or a character, and/or symbol and/or a segment of an identification construct of claim 1, wherein said segment of the identification construct is a section of the identification construct comprised of a digit or digits, and/or character or characters, and/or symbol or symbols and has a prearranged time range.

4. The computer-implemented method to enter, in a prearranged time range-based manner, a digit, and/or a character, and/or symbol and/or a segment of an identification construct of claim 1, wherein said digit or digits, and/or a character or characters, and/or symbol or symbols and/or segment or segments with a prearranged time range have a specific location or locations within the identification construct.

5. The computer-implemented method to enter, in a prearranged time range-based manner, a digit, and/or a character, and/or symbol and/or a segment of an identification construct of claim 1, wherein said time range is a prearranged time span assigned to a digit or digits, and/or character or characters, and/or symbol or symbols and/or segment or segments of the identification construct.

6. The computer-implemented method to enter, in a prearranged time range-based manner, a digit, and/or a character, and/or symbol and/or a segment of an identification construct of claim 1, further comprising of a configured and computer program coded to operate computers, cellular telephones, and other computing devices requiring the user to perform a login process.

7. The computer-implemented method to enter, in a prearranged time range-based manner, a digit, and/or a character, and/or symbol and/or a segment of an identification construct of claim 1, further comprising of a configured and computer program coded to authenticate the user during the login process as the user attempts to obtain access or into computers, network information systems, cellular telephones, and other computing devices requiring the user to perform a login process.

8. The computer-implemented method to enter, in a prearranged time range-based manner, a digit, and/or a character, and/or symbol and/or a segment of an identification construct of claim 1, further comprising of a software driven stopwatch which is computer program coded and integrated into the computing device's computer program code to let the user to select a time value within the prearranged time range of the digit or digits, and/or character or characters, and/or symbol or symbols and/or segment or segments of the identification construct.

9. The computer-implemented method to enter, in a prearranged time range-based manner, a digit, and/or a character, and/or symbol and/or a segment of an identification construct of claim 1, wherein the digits, numbers, characters, symbols and segments of identification constructs with prearranged time ranges are stored in a database.

10. The computer-implemented method to enter, in a prearranged time range-based manner, a digit, and/or a character, and/or symbol and/or a segment of an identification construct of claim 1, wherein the location of the digits, numbers, characters, and segments of the identification construct with a prearranged time range are stored in a database.

11. The computer-implemented method to enter, in a prearranged time range-based manner, a digit, and/or a character, and/or symbol and/or a segment of an identification construct of claim 1, further comprising of a computing device comprising of a processor, database system, entry device, display, wireless transmission system, and software to process the authentication data entered by the user.

12. A computer-implemented method to enter, in a prearranged time range-based manner a digit, and/or a number, and/or a character, and/or a segment of an identification construct, said method comprising the steps of:
a) a user identifying and selecting the specific location of the digit, character, symbol or segment within the user's identification construct that have a prearranged time range via a login pattern depicting the number of spaces of the identification construct;
b) a user entering the digits, and/or characters, and/or symbols and/or segments of the user's identification construct that are located before the prearranged time range element of the identification construct;
c) a software driven stopwatch that will start running after the entry of the last digit, character, symbol or segment preceding the prearranged time range digit, character, symbol or segment of the identification construct;
d) a user stopping the software driven stopwatch at the exact time value requested by the system's owner with the entry of the digit, character, symbol or segment of the identification construct that has been programmed with a time range;
e) a user entering the remaining digit(s), and/or character(s), and/or symbol(s) and/or segment of the user's identification construct;
f) a database search is initiated by the computer device to compare the values entered by the user with the user's identification stored data to corroborate user identification information after the user completes the entry of the identification construct;
g) a computer device providing a message through the computer device's display that the login process was successful or that the login process was not successful after the comparison of the user's entered values with the data stored in the database.
h) a computer device providing a second message through the computer device's display that the user was successful or was not successful at matching the exact time requested by the computer after the comparison of the user's entered values with the data stored in the database.

13) The computer-implemented method to enter, in a prearranged time range-based manner, a digit, and/or a character, and/or symbol and/or a segment of an identification construct of claim 12, further comprising of a software application operated through the computer device to be used as a probability game during the login process;

14) The computer-implemented method to enter, in a prearranged time range-based manner, a digit, and/or a character, and/or symbol and/or a segment of an identification construct of claim 12, wherein the said method utilizes the user's selected digit's time, or selected character's time, or selected symbol's time, or selected segment's time as an effort by the user to meet the system owner's instruction to stop the stopwatch at the exact time within the user's prearranged time range to acquire by chance a benefit.

15) The computer-implemented method to enter, in a prearranged time range-based manner, a digit, and/or a character, and/or symbol and/or a segment of an identification construct of claim 12, further comprising of a configured and computer program coded to be used by the user as a probability game during the login process as the user attempts to obtain access or into computers, network information systems, cellular telephones, and other computing devices requiring the user to perform a login process to have an opportunity to acquire a benefit by a service or product offeror, vendor or retailer.

16) The computer-implemented method to enter, in a prearranged time range-based manner, a digit, and/or a character, and/or symbol and/or a segment of an identification construct of claim 12 wherein the system owner's is a service or product offeror, vendor or retailer.
